(19) United States
(12) Patent Application Publication
(10) Pub. No.: US 2015/0379333 A1
(43) Pub. Date: Dec. 31, 2015

(54) Three-Dimensional Motion Analysis System

(71) Applicant: Eric L. Ingram, Gurley, AL (US)

(72) Inventor: Eric L. Ingram, Gurley, AL (US)

(21) Appl. No.: 14/317,550

(22) Filed: Jun. 27, 2014

(51) Int. Cl. G06K 9/00; H04N 13/02; G06T 15/00; G06T 13/40; A63B 24/00; H04N 7/18

(52) U.S. Cl. CPC G06K 9/00342; A63B 24/0062; H04N 7/18; G06T 15/00; G06T 13/40; H04N 13/02; A63B 2024/0065; H04N 2013/0081

(57) ABSTRACT

A system for recording and displaying motion of a user includes a computer-based controller comprising a computer-readable memory and a three-dimensional motion detector that comprises a red-green-blue video camera, a depth sensor and a microphone. The system records user motion and renders the user as a three-dimensional frame comprising a plurality of joints. The joints are tracked throughout the motion and then curves representing movement of the joint(s) are displayed.

### BRIEF DESCRIPTION OF THE DRAWINGS

The apparatus is described with reference to the accompanying drawings. In the drawings, like reference numbers indicate identical or functionally similar elements. Additionally, the left-most digit(s) of a reference number identifies the drawing in which the reference number first appears.

FIG. 1 is an illustration of an exemplary motion analysis system;

FIG. 1A is a user whose motion will be recorded by the motion analysis system of FIG. 1;

FIG. 1B depicts an exemplary “skeleton” rendered by the system of FIG. 1 and representative of the user of FIG. 1A;

FIG. 2 is a flowchart of an exemplary process executed by the system;

FIG. 3 depicts an exemplary user interface screen displayed by the system to enable recording;

FIG. 4 depicts an exemplary user interface screen displayed by the system to enable replaying recorded motion;

FIG. 5 depicts an exemplary user interface screen displayed by the system to enable configuration of the system;

FIG. 6 depicts an exemplary user interface screen displayed by the system to enable further system configuration with respect to recording;

FIG. 7 depicts an exemplary user interface screen displayed by the system to enable configuration of the system with respect to replay;

FIG. 8 is a functional schematic of an exemplary computer-based controller for use in the exemplary system; and

FIG. 9 is a functional schematic of an exemplary motion sensor device.

### DETAILED DESCRIPTION

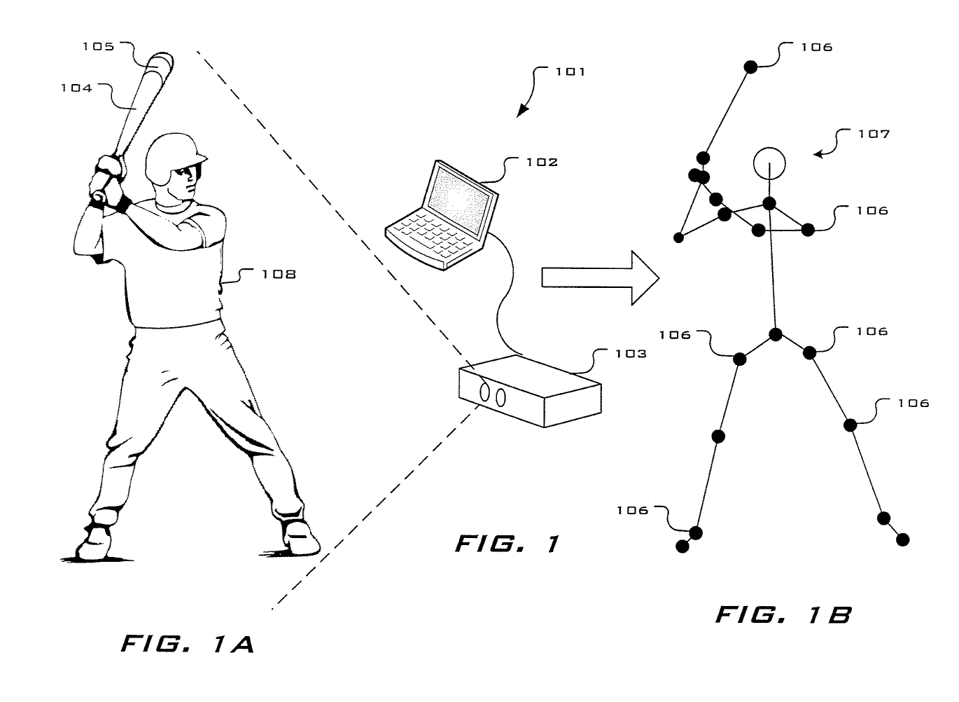

The various embodiments of the present invention and their advantages are best understood by referring to FIGS. 1 through 4 of the drawings. The elements of the drawings are not necessarily to scale, emphasis instead being placed upon clearly illustrating the principles of the invention. Throughout the drawings, like numerals are used for like and corresponding parts of the various drawings.

Furthermore, reference in the specification to “an embodiment,” “one embodiment,” “various embodiments,” or any variant thereof means that a particular feature or aspect of the invention described in conjunction with the particular embodiment is included in at least one embodiment of the present invention. Thus, the appearance of the phrases “in one embodiment,” “in another embodiment,” or variations thereof in various places throughout the specification are not necessarily all referring to its respective embodiment.

This invention may be provided in other specific forms and embodiments without departing from the essential characteristics as described herein. The embodiments described above are to be considered in all aspects as illustrative only and not restrictive in any manner.

FIG. 1A depicts an exemplary diagram of a three-dimensional motion analysis system 101 comprising a computer-based controller 102 and a three-dimensional (3D) motion input device 103.

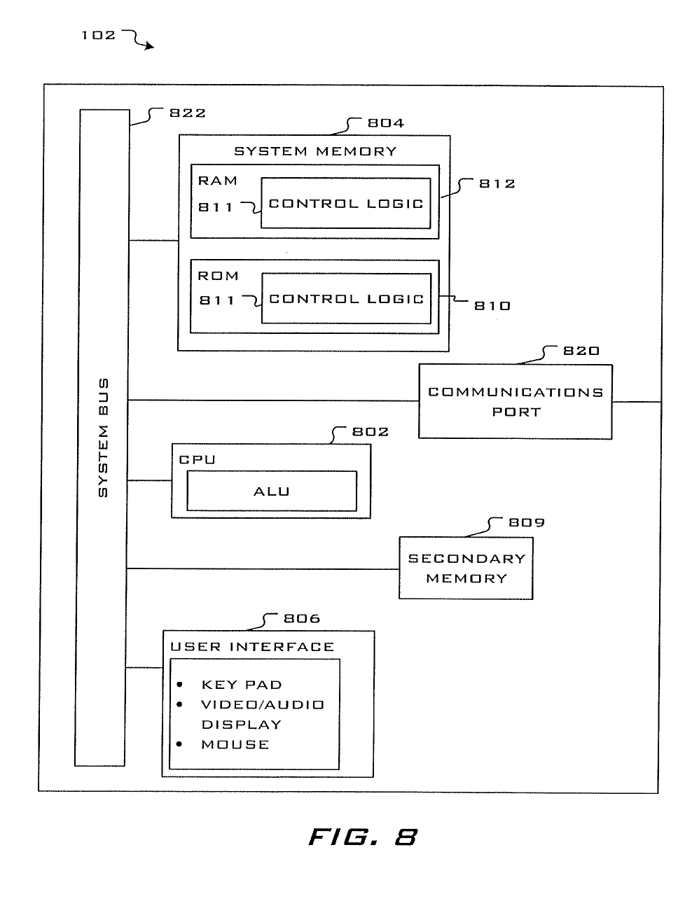

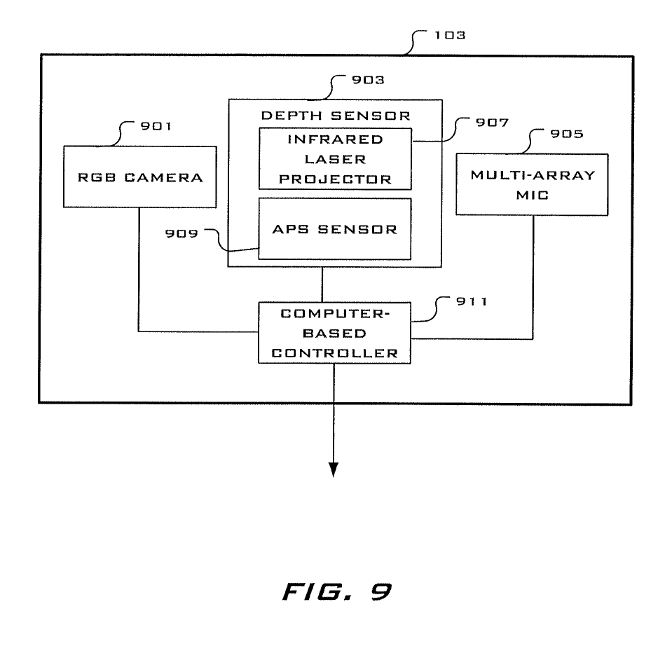

FIG. 8 shows a block diagram view of an exemplary computer-based controller 102. The computer-based controller 501 may include, but is not limited to, one or more processor devices including a central processing unit (CPU) 802. In an embodiment, the CPU 802 may include an arithmetic logic unit (ALU) that performs arithmetic and logical operations and one or more control units (CUs, not shown) that extract instructions and stored content from memory and then execute and/or process them, calling on the ALU when necessary during program execution. System memory 804 may include random-access memory (RAM) 812 or read-only memory (ROM) 810, each comprising a machine-readable storage medium having stored therein computer software and/or data. While the machine-readable storage medium is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine-readable storage medium” shall accordingly be taken to include, but not be limited to, solid-state memories, and optical and magnetic media.

The CPU 802 is responsible for executing all computer programs stored on the RAM 812 and ROM 810 which includes, as set forth, above the controller's user data analysis and the control response processes. The controller 102 can also include a secondary memory 809, also comprising a machine-readable storage medium that may be configured to store user data, either data associated with an individual user or with multiple users.

The computer-based controller 102 may also include a user interface 806 that allows a user to interact with the controller's software and hardware resources, and which may be a key pad, a video and/or audio display, and a mouse, or any other means now known or hereafter developed to allow a user to interact with the motion analysis system 101. The controller 102 also includes a system bus 822 that facilitates data communications among all the hardware resources of the computer-based controller 102. Finally, the controller 102 comprises a communications port 820 for coupling data from external devices to the system bus 822 for processing according to the control logic 911.

The computer-based controller 102, as will be appreciated by those skilled in the arts, may be one or more computer-based processors. Such a controller may be implemented by a field programmable gated array (FPGA), application specific integrated chip (ASIC), programmable circuit board (PCB), other suitable integrated chip (IC) device or other suitable electronic monitoring and control circuits. Additionally, the controller 102 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Controller 102 may also be one or more special-purpose processing devices such as an application specific integrated circuit (ASIC), a field programmable gate array (FPGA), a digital signal processor (DSP), network processor, or the like.

Control logic 811 (also called computer programs or software) is stored in the main memory 804 and/or secondary memory 809. Thus, controller 102 is configured with control logic 811 or other substrate configuration representing data and instructions, which cause the controller 102 to operate in a specific and predefined manner as, described hereinabove. The control logic 811 may advantageously be implemented as one or more modules. The modules may advantageously be configured to reside on the processor memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like. In programmable logic circuits, such as FPGAs, ASICs, Neural Net chips, etc., control logic can be partially or fully hardwired into functional circuits. Control logic 811 may be installed on the memory 804, 809 using a user interface 806 coupled to the communication bus 822 which may be any suitable input/output device. The user interface 806 may also be configured to allow a user to vary the control logic 811, either according to pre-configured variations or customizably.

It should also be understood that the programs, modules, processes, methods, and the like, described herein are but an exemplary implementation and are not related, or limited, to any particular processor, apparatus, or processor language. Rather, various types of general purpose computing machines or devices may be used with programs constructed in accordance with the teachings described herein. Similarly, it may prove advantageous to construct a specialized apparatus to perform the method steps described herein by way of dedicated processor systems with hard-wired logic or programs stored in nonvolatile memory, such as, by way of example, read-only memory (ROM), for example, components such as ASICs, FPGAs, PCBs, microcontrollers, or multi-chip modules (MCMs). Implementation of the hardware state machine so as to perform the functions described herein will be apparent to persons skilled in the relevant art(s).

With reference to FIG. 9, an exemplary 3D motion sensor device 103 preferably comprises a camera 901, e.g., an RGB camera, a depth sensor 903 and, optionally, a multi-array microphone 905. The depth sensor 903 includes an infrared (IR) laser projector 907 and an active-pixel sensor (APS) 909, preferably a monochrome CMOS sensor, comprising an integrated circuit with an array of pixel sensors, each pixel sensor comprising a photo detector and an amplifier. The camera 901, depth sensor 903 and the microphone 905 are all responsive to a computer-based device controller 911, similar to the controller 102 described above, which controls the functions of the 3D motion sensor 103.

In operation, the depth sensor 903 projects a plurality of infrared laser rays that are reflected and detected by the APS sensor 909. Each ray allows the system to construct an IR field map of an image based on distance and angle from the motion sensor 103. The IR mapped image is further mapped to a video image capture by the RGB camera 901. Finally, the microphone provides the ability for voice-control over the motion sensor 103. Control logic (described above) within the device controller 911 enables gesture recognition, facial recognition and voice recognition. Furthermore, the software allows the identification and tracking of a moving subject's joints. Devices that may be used as a motion sensor for this application include the Kinect® by the Microsoft Corporation.

With reference again to FIGS. 1, 1A and 1B, a subject 108 is oriented before the 3D motion sensor device 103. In this example, the subject is going to perform a baseball swing using a bat 104. It will be understood, however, that the concepts and processes described herein are applicable to analysis of other complex motions as well, such as, without limitation, golf swings, bowling, baseball pitching, kicking, punching, etc. So that the motion sensor device 103 may better detect the motion of the bat, a strip of colored tape 105 is placed on the bat near the end. Upon initialization, the motion sensor device 103 captures both video of the subject 108 and the IR map of the subject 108. The motion sensor 103 also constructs a model 107 (or “skeleton”) of the subject 108, comprising a rendering of tracking points 106 which represent the subject's major joints and the colored tape 105 on the end of the bat (or other piece of equipment depending upon the motion being analyzed). The major joints include the subject's left and right ankles, left and right feet, left and right and knees, left and right hips, center hip, left and right shoulder, center shoulder, the spine, left and right elbows, left and right wrists, and left and right hands.

The subject then performs the desired motion (swings the bat, golf club, etc.) and a video image of this motion is recorded by the 3D motion sensor device. At the same time, the model 107 corresponding to the video image is plotted throughout the motion. The video image and model data are transmitted to the controller 102. Control logic 911 with which the controller 102 is configured causes the controller to perform processes that will ultimately allow a user to view and analyze a subject's 108 motion.

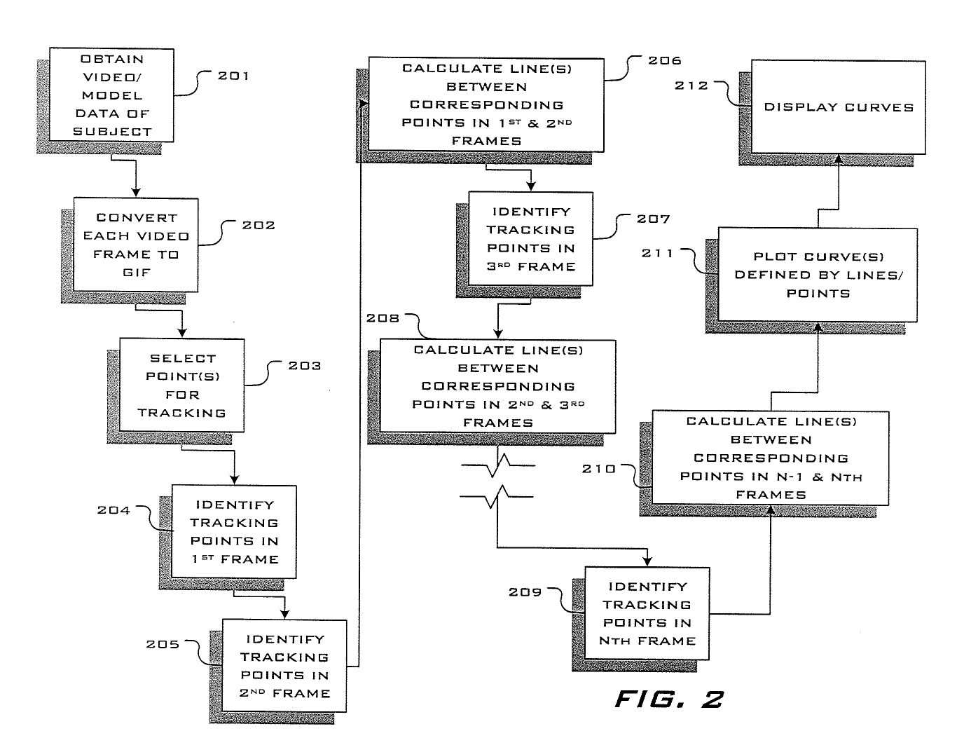

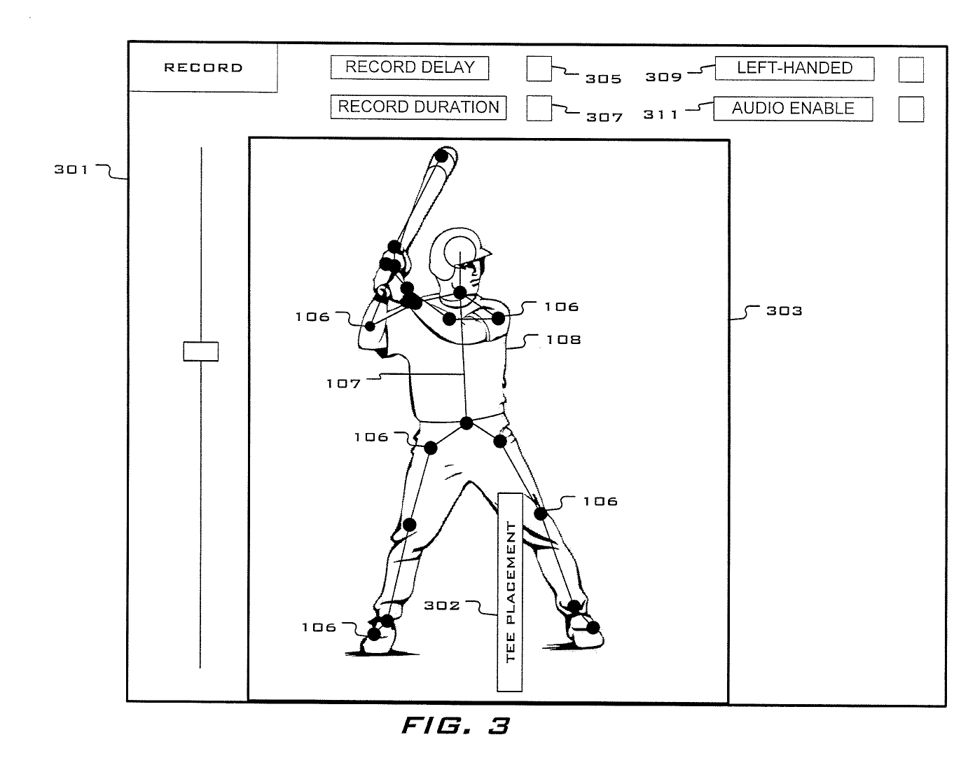

In that respect, FIG. 2 shows an exemplary process that may be performed by the controller 102, beginning with obtaining the video and model data 201 of the subject from the 3D motion sensor device 103. Next, the controller converts each frame of video into a separate electronic image file 202 (e.g., GIF, JPEG, BITMAP, TIFF, or any other image file format not known or later developed). At step 203, the system identifies the tracking points 106 from the skeleton 107 that will be tracked. This may be selected by the user via the user interface 806 as will be described below. Next, at 204, the system scans the first frame image to identify the tracking points 106 and then, identifies the tracking points 106 in the second frame image 205. Step 206 has the controller calculating the line between the corresponding joints from the first to the second frames. Similarly, the tracked joints in the third frame image are then identified 207 and the line between the corresponding tracking points 106 from the second to the third frames is calculated, and so on (steps 209, 210) until lines are calculated between the tracking points 106 to the final (Nth) frame. Next, curves are plotted 211 that are defined by the calculated lines and the tracking points 106. Finally, at step 212 the curves are displayed via the user interface 806.

As described above, the system 101 includes a user interface 806 through which a user may interact with the various processes performed by the system 101. In one embodiment, the user interface 806 comprises a video and audio display. The control logic 811 may also include instructions to generate a graphical user interface (GUI) to allow the user to interact with the system. FIG. 3 presents an exemplary GUI comprising a recording page 301 that allows the user to control recording of a subject's motion. The page 301 comprises a video window 303 which displays what the 3D motion sensor device 103 captures. For example, it displays a subject 108 assuming a baseball batting stance. The video display also show the model 107 rendered by the motion sensor device 103, including the plurality of tracking points 106. Also, shown on the display is a “tee placement” indicator 302 which generally indicates where a baseball tee would be placed, in this case for a right-handed batter. The page 301 also preferably includes control inputs for: (1) “record delay” 305, which allows the user to set a time period after initiating the recording function that the system actually begins recording; (2) “record duration” 307, which allows the user to define the length of the recording time; (3) “left-handed” 309, which allows the user to define where the tee placement indicator 302 will be placed in the case of a left-handed batter; and (4) “audio enable” 311 which allows the user to control the system functions with voice commands.

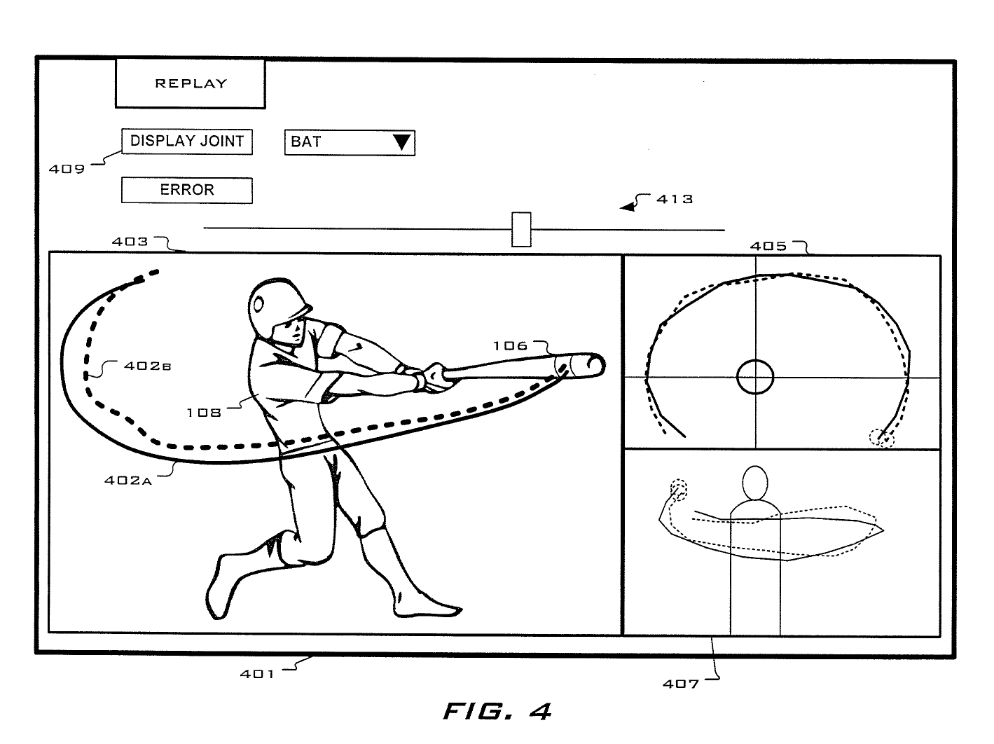

FIG. 4 depicts an exemplary GUI for a replay page 401 for allowing a user to control replay of the recorded video and display of the curves plotted modeling the motions of the various tracked joints. The replay page 401 preferably comprises a video replay window 403, in which the recorded video of the subject's motion is displayed. The system 101 may be configured to display the curve(s) 402 showing the travel of a selected joint 106 (in the example shown in the figure, the end of the bat). The page 401 may also include a rendered overhead view 405 and an elevation or horizontal view 407, displaying the respective curve(s) in each of those perspectives. The page 401 preferably includes an “display joint” button 409 that allows the user to select which joint 106 he or she desires to be displayed and for which the curve(s) are to be displayed on the replay. In addition, the page 401 may be configured to display a slider bar 413 that allows the user to select any frame within the recording.

In another embodiment, the subject 108 may be recorded multiple times each time performing the desired motion. From these multiple recordings, the user is allowed to identify the recording of the motion (as indicated by the displayed curve) is ideal. Other recorded motions are then compared to this “ideal curve” 402a (shown in solid line) and curves of compared motions 402b (shown in dashed line) showing deviations from that ideal motion curve 402a are displayed. An error button 411 may be used to allow the user to define the degree of error of the compared motion path 402b with respect to the ideal path 402a to be displayed. In other words, if the deviation of the compared motion is within the error amount set by the user, that portion of the compared motion 402b will appear to coincide with the ideal path 402a.

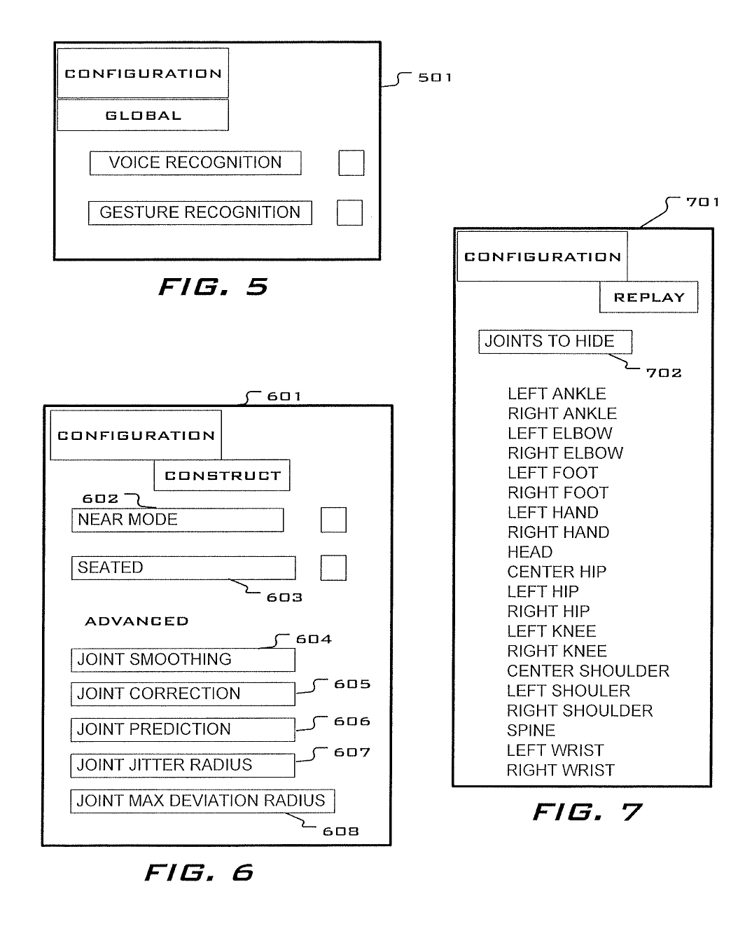

FIGS. 5, 6 and 7 show various exemplary interface pages that may be displayed allow the user to configure certain aspects of the system processes. FIG. 5 shows a global configuration page 501 that allows the user to select whether the system will be controlled by voice commands or gesture commands. In FIG. 6, an exemplary model construct configuration page 601 is shown which allows the user to manipulate how the system constructs the jointed skeleton 107. The “near mode” selection 602 adjusts the focal length of the three dimensional motion sensing device so that subjects within a near field of view are better model. “Seated” mode selection 603 constructs the subject's skeleton 107 from the tracking points 106 only from the waist up. Advanced model construction configuration includes “joint smoothing” 604 which allows a user to input a track smoothing value to specify the degree to which motion of the tracking points 106 from frame to frame is smoothed out compared to raw sensor data. “Joint correction” 605 allows the user to specify a value representing the degree to which the system's rendering of a joint 106 within a frame is corrected to the raw sensor data. The system includes a prediction feature that “predicts” the position of a joint 106 in future frames. The “joint prediction” selection 606 allows a user to specify the number of frames in the future the system predicts. The user may specify the “joint jitter radius” 607 which sets a radius from a joint 106 where deviant sensor data (“jitter”) beyond this radius is discarded when rendering the joint 106. The “joint maximum deviation radius” 608 allows a user to set a maximum radius within which a rendered (filtered) joint 106 position may deviate from the raw sensor data. An exemplary replay configuration page 701 may include a selection which allows a user to determine which tracking points 106 to display.

As described above and shown in the associated drawings, the present invention comprises a three-dimensional motion analysis system. While particular embodiments have been described, it will be understood, however, that any invention appertaining to the apparatus described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. A system for recording and displaying motion of a user comprising:
a computer-based controller comprising a computer-readable memory;
a three-dimensional motion detector responsive to said computer-based controller and comprising:
a red-green-blue video camera,
a depth sensor comprising an infrared laser projector and infrared sensor; and
a microphone; and
a display responsive to said computer-based controller; and
wherein said memory is configured with control logic adapted to cause the computer-based controller to:
receive input from said motion detector representing a video recording of the user in motion;
render a three-dimensional frame representing said user, said frame comprising a plurality of joints corresponding to joints of said user;
plot one or more curves representing motion of one or more joints throughout said video;
store data representing said one or more curves; and
display an animated rendering of said one or more curves based upon said data.

2. The system of claim 1, wherein said control logic is further adapted to cause the computer-based controller to allow a user to designate a curve of said one or more curves as an ideal curve representing an ideal motion of said one or more joints.
